(19) United States
(12) Patent Application Publication
(10) Pub. No.: US 2026/0027922 A1
(43) Pub. Date: Jan. 29, 2026

(54) MULTI-CHARGING CONNECTOR AND METHOD OF OPERATING THE SAME

(71) Applicants: HYUNDAI MOTOR COMPANY, SEOUL (KR); KIA CORPORATION, SEOUL (KR)

(72) Inventor: Min Gyu Lee, Hwaseong-si (KR)

(73) Assignees: HYUNDAI MOTOR COMPANY, SEOUL (KR); KIA CORPORATION, SEOUL (KR)

(21) Appl. No.: 19/043,743

(22) Filed: Feb. 3, 2025

(30) Foreign Application Priority Data
Jul. 29, 2024 (KR) 10-2024-0100302

(51) Int. Cl. B60L 53/16; H01R 13/642; H01R 27/00

(52) U.S. Cl. CPC B60L 53/16; H01R 13/642; H01R 27/00; H01R 2201/26

(57) ABSTRACT

A multi-charging connector includes a first connector unit connected to a charging unit of an electric vehicle, a second connector unit connected to the charging unit of the electric vehicle and having a different charging standard from the first connector unit, a rotation driver unit that rotates the first connector unit and the second connector unit, and a controller that controls the driving of the rotation driver unit.

### CROSS REFERENCE TO RELATED APPLICATIONS

This application claims priority to and the benefit of Korean Patent Application No. 10-2024-0100302, filed on Jul. 29, 2024, the disclosure of which is incorporated herein by reference in its entirety.

### BACKGROUND

### 1. Field

Various embodiments of the present disclosure relate to a charging connector capable of charging an electric vehicle, and more particularly, to a connector device capable of charging an electric vehicle more simply and efficiently.

### 2. Discussion of Related Art

Currently, a charging connector of an electric vehicle uses a combination of Combined Charging System (CCS) and North American Charging Standard (NACS) methods.

A standard of the NACS method has recently been adopted as a standard, but since many stations and vehicles use a combination of the CCS and NACS standard methods, there is still inconvenience that charging should be performed using a conversion gender when necessary.

That is, as the charging connector is limited by conventional non-unified electric charging standard methods, the use of charging infrastructure is inconvenient, and there is a limitation in providing a charging experience due to the inability to standardize the charging connector.

### SUMMARY

The present disclosure is directed to providing a common multi-charging connector including connector devices of different standards in an integrated form.

Further, the present disclosure is directed to detecting an inlet shape of the vehicle so that a connector of a specific standard is automatically selected.

In addition, the present disclosure is directed to allowing a user to directly select a specific connector through a connector selection button.

The technical objectives to be achieved by the present disclosure are not limited to the above-mentioned technical objectives, and other objectives which are not mentioned will be clearly understood by those skilled in the art from the following description.

A multi-charging connector according to various embodiments of the present disclosure includes a first connector unit connected to a charging unit of an electric vehicle. a second connector unit connected to the charging unit of the electric vehicle and having a different charging standard from the first connector unit. a rotation driver unit that rotates the first connector unit and the second connector unit; and a controller that controls the driving of the rotation driver unit.

In some embodiments, the rotation driver unit may include a rotary electrical connection unit.

In some embodiments, the controller may recognize a shape of a vehicle inlet adjacent to the multi-charging connector and rotate the first connector unit and the second connector unit based on the recognized shape.

In some embodiments, the multi-charging connector may further include a connector selection button that rotates the first connector unit and the second connector unit through a user input.

In some embodiments, the multi-charging connector may further include a cross-shaft gear that applies mechanical energy transmitted from the motor to the rotary electrical connection unit.

In some embodiments, the multi-charging connector may further include a first motor that drives the rotary electrical connection unit and a second motor that drives the first connector unit and the second connector unit.

A method of charging an electric vehicle through a multi-charging connector according to various embodiments of the present disclosure includes recognizing a shape of a vehicle inlet adjacent to the multi-charging connector, determining a charging connector based on the recognized shape of the vehicle inlet; and rotating a connector unit of the multi-charging connector according to the determined charging connector.

### BRIEF DESCRIPTION OF THE FIGURES

The above and other objects, features and advantages of the present invention will become more apparent to those of ordinary skill in the art by describing exemplary embodiments thereof in detail with reference to the accompanying drawings, in which:

FIGS. 1A and 1B are an exemplary diagrams illustrating Combined Charging System (CCS) standard and North American Charging Standard (NACS) standard charging connectors;

FIG. 2 is a configuration diagram of a multi-charging connector according to an embodiment of the present disclosure;

FIG. 3 is an exemplary diagram of a multi-charging connector according to various embodiments of the present disclosure;

FIG. 4 is an exemplary diagram illustrating a state in which a connector unit in FIG. 3 is rotated;

FIG. 5 is an exemplary diagram illustrating a connector unit according to the embodiment of the present disclosure;

FIG. 6 is an exemplary diagram illustrating a rotary electrical connection unit according to the embodiment of the present disclosure;

FIG. 7 is an exemplary diagram of a multi-charging connector according to another embodiment of the present disclosure; and

FIG. 8 is a flowchart illustrating a method of operating a multi-charging connector according to various embodiments of the present disclosure.

### DETAILED DESCRIPTION

Hereinafter, preferred embodiments of the present disclosure will be described in detail with reference to the accompanying drawings.

However, the technical spirit of the present disclosure is not limited to some embodiments to be described, but may be implemented in various different forms, and one or more of the components between the embodiments may be selectively combined and substituted within the technical spirit of the present disclosure.

Further, the terms (including technical and scientific terms) used in the embodiments of the present disclosure may be interpreted as meanings which may be generally understood by those skilled in the art unless specifically defined and described, and terms which are generally used such as terms defined in a dictionary may be understood in consideration of the contextual meanings in the related art.

In addition, the terms used in the embodiments of the present disclosure are not to limit the present disclosure but to describe the embodiments.

In the present specification, the singular form may also include the plural form unless the context clearly indicates otherwise and when “at least one (or one or more) of A, B, and C” is described, it may include one or more of all combinations of A, B, and C.

Further, terms such as first, second, A, B, (a), (b), and the like may be used to describe the components of the embodiment of the present disclosure.

These terms are only provided to distinguish the components from other components, and the nature, sequence, order, or the like of the corresponding components are not limited by these terms.

Further, when a specific component is disclosed as being “connected,” “coupled,” or “linked” to another component, this may include not only a case where the certain component is directly being connected, coupled, or linked to the other component, but also a case where the certain component is indirectly being connected, coupled, or linked to the other component with another component interposed therebetween.

In addition, when one component is disclosed as being formed “on or under” another element, the term “on or under” includes not only a case in which two components are in direct contact with each other, but also a case in which one or more other components are formed or disposed between the two components. In addition, when the term “on or under” is expressed, it may mean not only an upward direction but also a downward direction based on one component.

Hereinafter, the embodiments will be described in detail with reference to the accompanying drawings, and the same reference numerals may be given to the same or corresponding components regardless of the reference numerals, and redundant descriptions thereof will be omitted.

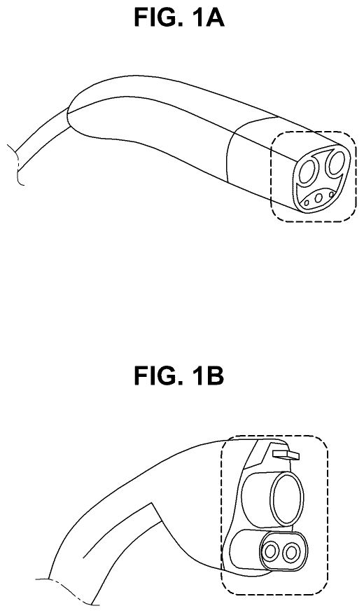

FIG. 1 is an exemplary diagram illustrating conventional Combined Charging System (CCS) standard and North American Charging Standard (NACS) standard charging connectors.

As shown in FIG. 1, currently, there are two types of charging connectors for electric vehicles: FIG. 1A shows a NACS standard connector and FIG. 1B shows a CCS standard connector. Since these two types of charging connectors are mixed, which causes inconvenience to drivers, the present disclosure provides a common multi-charging connector 10 that satisfies both the CCS standard and the NACS standard in one connector without a separate device.

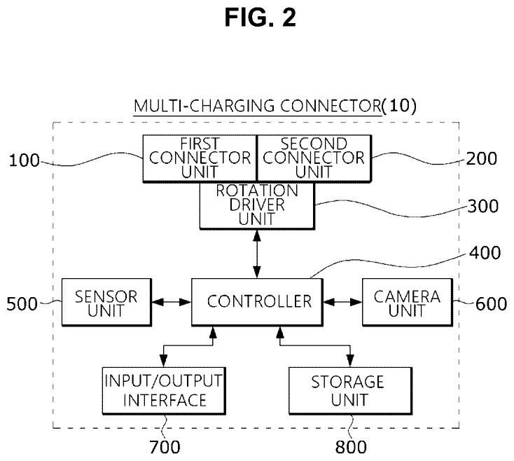

FIG. 2 is a configuration diagram of a multi-charging connector 10 according to an embodiment of the present disclosure.

The multi-charging connector 10 may include a first connector unit 100, a second connector unit 200, a rotation driver unit 300, a controller 400, a sensor unit 500, a camera unit 600, an input/output interface 700, and a storage unit 800. This multi-charging connector 10 is a configuration which supplies power to an electric vehicle at an electric charging station or the like, and performs an integrated connector function capable of charging the electric vehicle with different types of standards. Meanwhile, a charging cable of an electric vehicle charging station is connected to the multi-charging connector 10 to supply power, and the structure of the charging cable is omitted for convenience.

The first connector unit 100 is a connector of a first charging standard type that is connected to a charging unit of the electric vehicle. For example, the first connector unit may be a charging connector of the NACS standard which is an electric vehicle charging method adopted by TESLA®.

The second connector unit 200 is a connector of a second charging standard type that is connected to the charging unit of the electric vehicle, and is a connector that provides a charging method of a different standard from the first connector unit 100. For example, the second connector unit may be a charging connector of a CCS1 standard.

Meanwhile, the term ‘connector unit’ in this document for convenience of description may be interpreted as referring to either the first connector unit 100 or the second connector unit 200 or both the first connector unit 100 and the second connector unit 200. The connector units 100 and 200 are connected to an inlet which is a charging socket provided in the charging unit of the electric vehicle. The common connector units 100 and 200 may be controlled to selectively supply power to the vehicle through a connector of a specific standard by combining, for example, an internal circuit required for the NACS standard and an internal circuit required for the CCS1 standard.

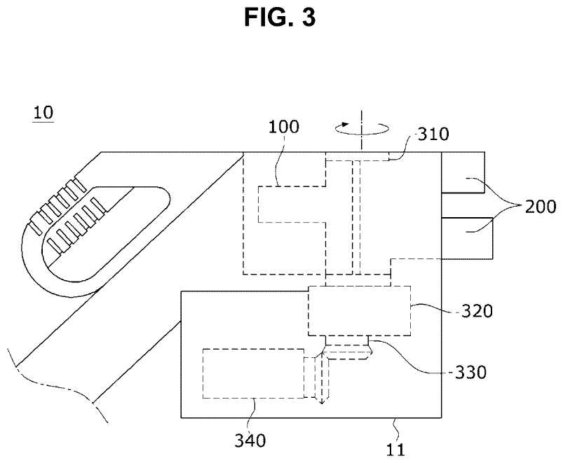

The rotation driver unit 300 performs a function of rotating the first connector unit and the second connector unit. To this end, the rotation driver unit 300 may include at least one of a rotary shaft 310, a rotary electrical connection unit 320, a gear unit 330, and a motor unit 340, and a specific configuration of the rotation driver unit 300 will be described below in detail with reference to FIG. 3.

The controller 400 may control the overall operation of the multi-charging connector 10 and a signal flow between internal components of the multi-charging connector 10 and perform a data processing function of processing data. The controller 400 may include at least one processor.

The controller 400 according to the embodiment of the present disclosure may control the rotation of the connector units 100 and 200. Specifically, as the controller 400 controls the driving of the rotation driver unit 300, since the first connector unit 100 and the second connector unit 200 are rotated, any one connector may be selectively exposed to the outside.

The processor may execute instructions stored in a memory of the storage unit 800 to be described below to generate information or control configurations of the multi-charging connector 10. The processor may include a central processing unit (CPU), a microprocessor unit (MPU), a micro controller unit (MCU), a graphics processing unit (GPU), or any type of processor well known in the technical field of the present disclosure.

The sensor unit 500 may detect the distance and shape of the vehicle inlet adjacent to the multi-charging connector 10 and may transmit the detected information to the controller 400. The sensor unit 500 may include a camera sensor capable of acquiring image information around the multi-charging connector 10, a light detection and ranging (LiDAR) sensor capable of acquiring distance information, or a radar sensor. As a non-limiting example, the camera sensor may be included in the sensor unit 500 as described above, but may also be implemented as a separate module through the camera unit 600.

In various embodiments, the sensor unit 500 may recognize a vehicle inlet type through a 2D vision or 3D vision supporting a region of interest (ROI) through a light-emitting diode (LED), and transmit the recognized information to the controller 400.

The camera unit 600 may include at least one camera, and accordingly, may collect images around the multi-charging connector 10.

At least some configurations of the sensor unit 500 and the camera unit 600 may overlap each other, and at least some configurations necessary for recognizing the shape of the vehicle inlet adjacent to the multi-charging connector 10 may be configured as one module (for example, a vision system).

The input/output interface 700 is a configuration which supports various inputs and outputs related to the operation of the multi-charging connector 10. According to one embodiment, the input/output interface 700 may include a display unit that displays information related to charging. The display unit may display a charging start and end state of the electric vehicle, a charging state, and information of the connector unit 100 or 200 currently being charged (for example, which standard connector is currently used for charging or the like), but is not limited thereto. The display unit may include a touchable display panel.

According to one embodiment, the input/output interface 700 may include a connector selection button. The user may rotate the first connector unit 100 and the second connector unit 200 through an input of pressing the connector selection button. For example, when the user presses the connector selection button, the currently exposed connector may be rotated to be inserted into the main body of the multi-charging connector 10, and the connector units 100 and 200 may be rotated so that the connector located inside the main body is exposed to the outside of the main body of the multi-charging connector 10.

In another embodiment, when the user presses the connector selection button, the multi-charging connector 10 may display a screen for selecting a specific connector through the display unit, and the specific connector may be rotated to be exposed toward the vehicle inlet in response to a user input for selecting the specific connector.

This connector selection button may be located in a region (for example, an upper surface) adjacent to the handle of the multi-charging connector 10, but is not limited thereto.

The storage unit 800 may store data received or generated from the controller 400 or other components of the multi-charging connector 10. The storage unit 800 may include, for example, a memory, a cache, a buffer, and the like, and may be configured with software, firmware, hardware, or a combination of at least two or more thereof. The memory may store instructions related to the control of the multi-charging connector 10 and data for generating information.

Although not shown, the multi-charging connector 10 may further include a power supply unit which supplies power by itself (for example, a battery) or externally and a circuit module for electrical connection between at least some configurations of the multi-charging connector 10. Further, the multi-charging connector 10 may include a circuit module for supplying power for each connector so that power is selectively supplied to the vehicle through a specific connector.

Hereinafter, the configuration of the multi-charging connector 10 will be described in more detail with reference to FIGS. 3 to 7.

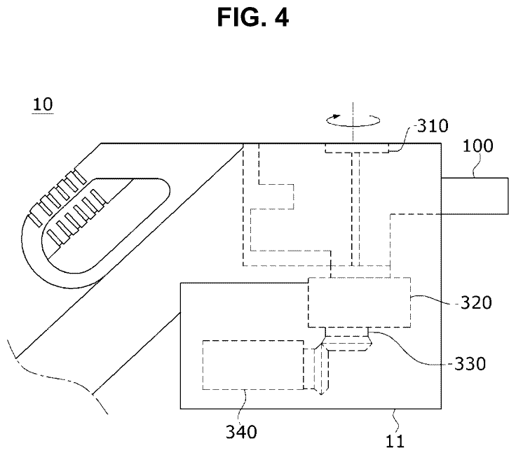

FIG. 3 is an exemplary diagram of the multi-charging connector 10 according to various embodiments of the present disclosure, and FIG. 4 is an exemplary diagram illustrating a state in which the connector unit in FIG. 3 is rotated. The controller 400, the sensor unit 500, the camera unit 600, the input/output interface 700, and the storage unit 800 described above may be omitted for convenience in the drawings, but these configurations may be configured to be located in at least a portion of the multi-charging connector 10 disclosed in FIGS. 3 to 7.

Referring to FIG. 3, a main body 11 may form the overall appearance of the multi-charging connector 10 and include an internal space in which components of the multi-charging connector 10 may be disposed. The main body 11 is illustrated in a specific shape in the drawings, but is not limited thereto and may be formed in various shapes.

The multi-charging connector 10 includes the first connector unit 100 and the second connector unit 200 that may be connected to the charging unit of an electric vehicle. The first connector unit 100 and the second connector unit 200 may have different charging standards. For reference, in FIG. 3, the second connector unit 200 (for example, the CCS standard) is exposed to the outside of the main body 11 of the multi-charging connector 10 to be connected to the vehicle inlet.

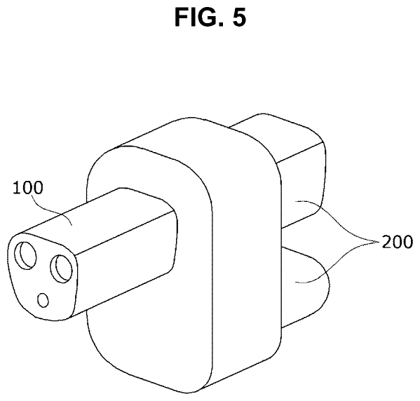

For reference, a conceptually extracted configuration of the connector units 100 and 200 in the multi-charging connector 10 is disclosed in FIG. 5. As shown in FIG. 5, the connector units 100 and 200 may be formed so that connectors of different charging standards are exposed by rotation.

Referring to FIG. 3 again, the rotation driver unit 300 may be configured inside the main body of the multi-charging connector 10 to rotate the connector units 100 and 200. The rotation driver unit 300 may include at least one of the rotary shaft 310, the rotary electrical connection unit 320, the gear unit 330, and the motor unit 340.

The rotary shaft 310 is a basic shaft which rotates the connector units 100 and 200, and may be coupled to an empty space inside the connector units 100 and 200 and coupled to the connector units 100 and 200 so that the connector units 100 and 200 may be rotated according to the rotation of the rotary shaft 310. One end of the rotary shaft 310 may be connected to the rotary electrical connection unit 320 (for example, a slip ring) to receive rotational driving, but is not limited thereto, and may be independently rotated by other motors or the like.

Meanwhile, the rotary shaft 310 is illustrated as a separate configuration from the rotary electrical connection unit 320, but according to various embodiments, the rotary shaft 310 may also be integrally formed with the rotary electrical connection unit 320.

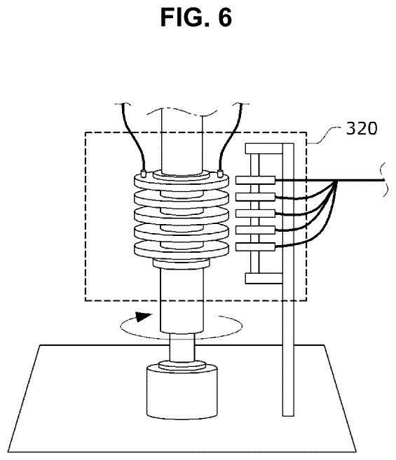

The rotary electrical connection unit 320 performs a function of branching an incoming cable and supplying the cable to the first connector unit 100 and the second connector unit 200. A slip ring shown in FIG. 6 may be included as an example of this rotary electrical connection unit 320. The slip ring is an electrical/mechanical component also called a rotary joint, a rotary connector, or the like, and is a configuration in which transmission is possible without twisting of wires when supplying power or signal lines to rotating equipment. This slip ring may be used in an electronic system that requires rotation while transmitting power or signals. The above rotary electrical connection unit 320 may allow power or signals to be smoothly supplied to the rotatable integrated connector units 100 and 200 without interruption.

As shown in FIG. 3, one end of the rotary electrical connection unit 320 is connected to the gear unit 330, and the other end thereof may apply a rotational force to the rotary shaft 310. As described above, the rotary electrical connection unit 320 may be integrally formed with the rotary shaft 310.

The gear unit 330 transmits mechanical energy generated by the driving of the motor unit 340 to the rotary electrical connection unit 320. According to one embodiment, the gear unit 330 may be configured as a pair of cross-shaft gears such as bevel gears as shown in FIG. 3 to rotate the connector units 100 and 200 by transmitting energy through the motor unit 340.

The motor unit 340 is a configuration which generates a rotational force from electrical energy, and ultimately generates driving energy which rotates the connector units 100 and 200. In the embodiment of the present disclosure, the motor unit 340 may include a servo motor to enable position control within a certain range by the controller 400. The motor unit 340 may be driven or controlled by being electrically connected to the power supply unit and the controller 400.

When the connector units 100 and 200 are rotated as indicated by the arrow in FIG. 3 based on the rotary shaft 310, the first connector unit 100 is exposed to the outside of the main body 11 of the multi-charging connector 10 as shown in FIG. 4.

Meanwhile, the inside of the main body of the multi-charging connector 10 may have a thickness greater than or equal to a certain value so as not to interfere with an internal frame or other configurations in a path exposed and hidden by the rotation of the connector units 100 and 200. For example, in the process of being converted to FIG. 4 through the rotation in FIG. 3, at least a partial region of the internal space of the main body 11 may have a thickness greater than a diameter of a virtual circle drawn by the rotation of the connector units 100 and 200.

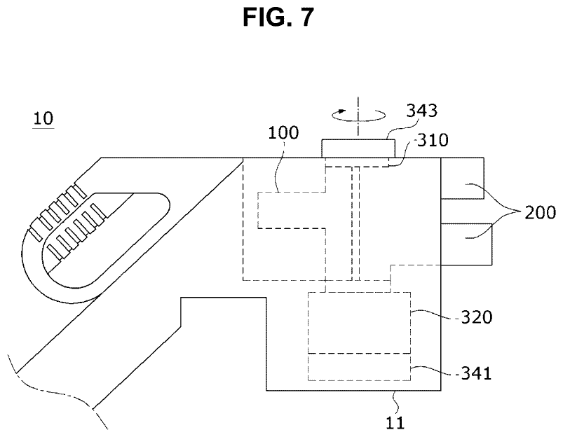

The following FIG. 7 will describe a multi-charging connector 10 according to another embodiment of the present disclosure.

FIG. 7 illustrates a configuration capable of respectively controlling connector units 100 and 200 and a rotary electrical connection unit 320 through two motors located in different regions inside a main body of the multi-charging connector 10.

Specifically, in FIG. 7, the gear unit 330 in FIG. 4 is omitted, and a first motor 341 for rotating the rotary electrical connection unit 320 and a second motor 343 for rotating the connector units 100 and 200 are each included in the multi-charging connector 10. A controller 400 independently controls each of the first motor 341 and the second motor 343, so that the rotary electrical connection unit 320 such as a slip ring and the connector units 100 and 200 may be driven, respectively. The above structure may be more efficient when a driving force is not transmitted between the rotary electrical connection unit 320 and the connector units 100 and 200. Through the configuration in FIG. 7, the multi-charging connector 10 may be implemented even with a smaller internal space structure compared to FIG. 4.

Meanwhile, in the above-described FIGS. 3 to 7, the internal structure may vary according to the specifications of the module and the component, and electrical circuit structures may be included or connected to transmit and receive power or signals between internal configurations.

According to various embodiments, the multi-charging connector 10 may select a specific connector by a user input or a predetermined inlet shape recognition process.

For example, when the currently exposed CCS type connector does not fit the vehicle (that is, when the charging inlet of the electric vehicle is an NACS type), the multi-charging connector 10 may rotate the connector units 100 and 200 automatically or according to the user input.

The method of rotating the connector by the user may be performed, for example, by the user pressing the connector selection button of the input/output interface 700 or performing an operation of selecting a specific connector through the display unit. In response to such a user input, the controller 400 may control at least some configurations of the multi-charging connector 10 so that the connector units 100 and 200 are rotated.

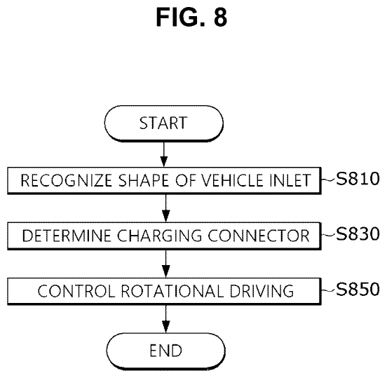

In addition, an operation of automatically rotating the connector units 100 and 200 will be described through FIG. 8. FIG. 8 is a flowchart illustrating a method of operating the multi-charging connector 10 according to various embodiments of the present disclosure.

When an electric vehicle is adjacent to the multi-charging connector 10 located at the electric charging station or the like for charging, the multi-charging connector 10 may recognize the shape of the inlet in the charging unit of the vehicle (S810). In this case, the recognition of the shape of the inlet may be recognized in a visual manner through at least one of the sensor unit 500 and the camera unit 600.

The controller 400 may collect information on the recognized inlet shape and determine which connector to select as the charging connector (S830). For example, the charging standard connector method of the corresponding vehicle may be identified by comparing the collected image information with pre-stored information, but is not limited to a specific method.

As the specific charging connector is selected, the controller 400 may control the rotational driving of the multi-charging connector 10 (S850). Specifically, the controller 400 may rotate the connector units 100 and 200 so that the selected connector is exposed to the outside of the multi-charging connector 10 and may be connected to the vehicle inlet.

Through the above-described embodiments of the present disclosure, as common connectors of different charging standards are provided in an integrated form without conflict, and the connector is provided by automatically recognizing a charging inlet shape, a charging experience which is convenient for a user may be expanded and a charging infrastructure may be continuously provided.

The term ‘˜unit’ used in the embodiment means a software or hardware component, and the ‘˜unit’ performs certain roles. However, the ‘˜unit’ may be a conveniently classified configuration to describe a specific function, and at least some configurations (for example, a sensor unit, a camera unit, an input/output interface, a storage unit, and the like) of the ‘˜units’ mentioned in the document may be implemented as a single configuration (for example, a controller, a circuit module, a processor, a command of a memory, or the like). The components and the functions provided in the ‘˜units’ may be combined into a smaller number of components and ‘˜units’ or may be further separated into additional components and ‘˜units’. Further, the components and the ‘˜units’ may be implemented to play one or more CPUs in a device or secure multimedia card.

A charging experience can be provided to electric vehicle customers regardless of connector specifications by selectively providing charging connectors of different charging standards in one device through a multi-charging connector according to various embodiments of the present disclosure.

Further, as the multi-charging connector is able to automatically or manually select a connector of a specific standard, a charging infrastructure which satisfies convenience and needs of customers can be provided.

Although preferred embodiments of the present disclosure are described above, those skilled in the art may understand that the present disclosure can be variously modified and changed within the scope not departing from the spirit and scope of the present disclosure described in the following claims.

1. A multi-charging connector comprising:
a first connector unit connected to a charging unit of an electric vehicle;
a second connector unit connected to the charging unit of the electric vehicle and having a different charging standard from the first connector unit;
a rotation driver unit configured to rotate the first connector unit and the second connector unit; and
a controller configured to control driving of the rotation driver unit.

2. The multi-charging connector of claim 1, wherein the rotation driver unit includes a rotary electrical connection unit.

3. The multi-charging connector of claim 1, wherein the controller is configured to recognize a shape of a vehicle inlet adjacent to the multi-charging connector, and to rotate the first connector unit and the second connector unit based on the recognized shape.

4. The multi-charging connector of claim 1, further comprising a connector selection button configured to rotate the first connector unit and the second connector unit through a user input.

5. The multi-charging connector of claim 2, further comprising:
a motor; and
a cross-shaft gear configured to apply mechanical energy transmitted from the motor to the rotary electrical connection unit.

6. The multi-charging connector of claim 2, further comprising:
a first motor configured to drive the rotary electrical connection unit; and
a second motor configured to drive the first connector unit and the second connector unit.

7. A method of charging an electric vehicle through a multi-charging connector, comprising:
recognizing, by a controller, a shape of a vehicle inlet adjacent to the multi-charging connector;
determining, by the controller, a charging connector based on the recognized shape of the vehicle inlet; and
rotating a connector unit of the multi-charging connector according to the determined charging connector.

8. The method of claim 7, wherein the connector unit includes a first connector unit connected to a charging unit of an electric vehicle, and a second connector unit connected to the charging unit of the electric vehicle and having a different charging standard from the first connector unit.

9. The method of claim 8, wherein the multi-charging connector further includes a rotary electrical connection unit.

10. The method of claim 9, wherein the multi-charging connector further includes a motor and a cross-shaft gear that applies mechanical energy transmitted from the motor to the rotary electrical connection unit.

11. The method of claim 8, wherein the multi-charging connector further includes a connector selection button that rotates the first connector unit and the second connector unit through a user input.

12. The method of claim 8, wherein the multi-charging connector further includes a first motor that drives the rotary electrical connection unit, and a second motor that drives the first connector unit and the second connector unit.
